(19) United States
(12) Patent Application Publication
(10) Pub. No.: US 2016/0157046 A1
(43) Pub. Date: Jun. 2, 2016

(54) APPARATUS, SYSTEM AND METHOD OF PROXIMITY ESTIMATION

(71) Applicant: INTEL IP CORPORATION, Santa Clara, CA (US)

(72) Inventors: Raz Weizman, Ra'anana (IL); Eddy Kvetny, Rishon-Lezion (IL)

(21) Appl. No.: 14/556,272

(22) Filed: Dec. 1, 2014

(51) Int. Cl. H04W 4/00; H04W 24/08

(52) U.S. Cl. CPC H04W 4/008; H04W 24/08

(57) ABSTRACT

Some demonstrative embodiments include apparatuses, devices, systems and methods of proximity estimation. For example, a first Bluetooth (BT) device may include a transmitter to transmit a first BT message to a second BT device; a receiver to receive from the second BT device a second BT message including an indication of a received signal strength of the first message; and a proximity estimator to estimate a proximity between the first and second BT devices based on the received signal strength of the first BT message.

### TECHNICAL FIELD

Embodiments described herein generally relate to proximity estimation.

### BACKGROUND

Bluetooth (BT) Low Energy (BLE) technology provides connectivity between BT mobile devices and a variety of systems, e.g., cars, exercise devices, computers, tablets and the like.

The BLE technology supports a relatively low power consumption of the BT mobile devices. For example, a BT mobile device may be a small sensor, a watch, or a Smartphone having a battery with limited power supply, and the BLE technology may enable the BT mobile device to communicate with the variety of systems using relatively low power consumption.

According to the BLE technology, a first BT device and a second BT device may establish a connection between the first and second BT devices, to enable exchanging data between the first BT device and the second BT device.

The first and the second BT devices may perform one or more proximity measurements to determine a proximity between the first and second BT devices, for example, to determine if the distance between the first and second BT devices is less than a predefined distance.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic sequence diagram of operations and interactions between a first Bluetooth (BT) device and a second BT device, in accordance with some demonstrative embodiments.

FIG. 3 is a schematic flow chart illustration of a method of proximity estimation, in accordance with some demonstrative embodiments.

FIG. 4 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Bluetooth device, a Bluetooth Low Energy (BLE) device, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Bluetooth standards (“the Bluetooth standards”), e.g., including Bluetooth specification V 1.0, Dec. 1, 1991, Bluetooth specification V 4.0, Jun. 30, 2010, and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec. 2012); 802.11x) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, a Bluetooth device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN. Other embodiments may be used in conjunction with any other suitable wireless communication network, for example, a wireless area network, a “piconet”, a WPAN, a WVAN and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

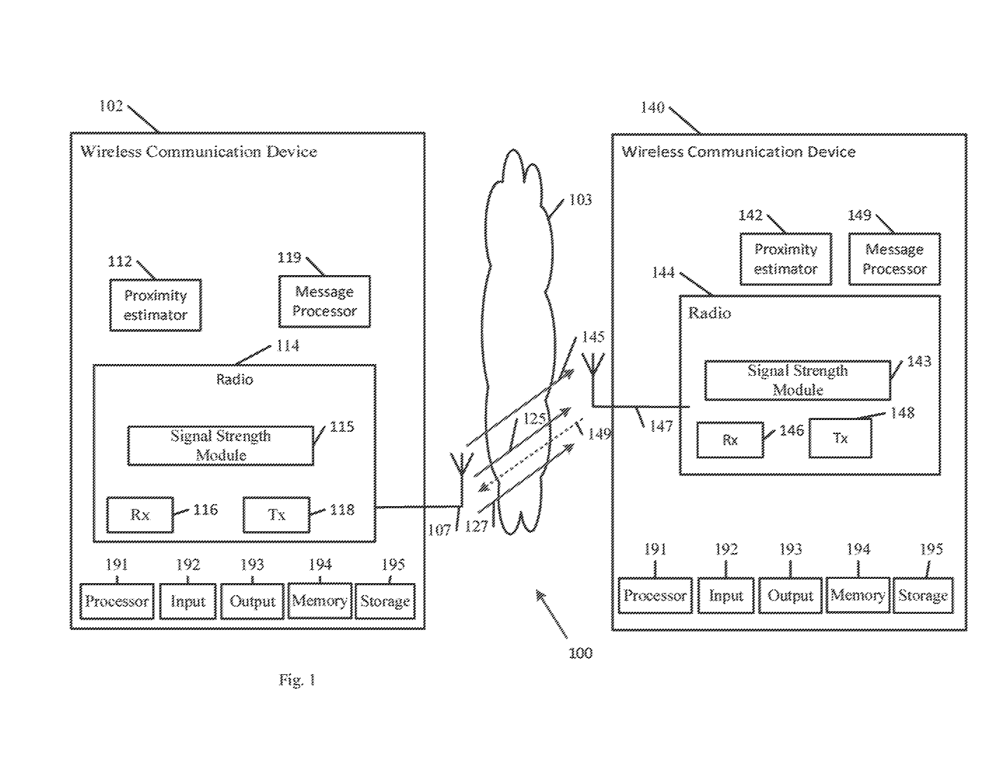

Reference is now made to FIG. 1, which schematically illustrates a block diagram of a system 100, in accordance with some demonstrative embodiments.

As shown in FIG. 1, in some demonstrative embodiments, system 100 may include one or more wireless communication devices capable of communicating content, data, information and/or signals via a wireless medium (WM) 103. For example, system 100 may include a wireless communication device 102 and/or a wireless communication device 140.

In some demonstrative embodiments, WM 103 may include a Bluetooth (BT) communication channel.

In some demonstrative embodiments, system 100 may include one or more BT devices capable of communicating wireless communication signals over the BT communication channel. For example, device 102 may perform the functionality of a first BT device, and/or device 140 may perform the functionality of a second BT device.

In some demonstrative embodiments, system 100 may include one or more Bluetooth Low Energy (BLE) devices capable of communicating wireless communication signals according to a BLE communication scheme. For example, device 102 may perform the functionality of a first BLE device, and/or device 140 may perform the functionality of a second BLE device.

In some demonstrative embodiments, device 102 may perform the functionality of a BLE Central Host device, and/or device 140 may perform the functionality of a BLE Peripheral Host device.

In other embodiments, devices 102 and/or 140 may communicate wireless communication signals over the BT communication channel according to any other BT communication scheme.

In some demonstrative embodiments, device 102 and/or device 140 may include, for example, a User Equipment (UE), a mobile computer, a mobile device, a laptop computer, an Internet of Things (IoT) device, a notebook computer, a tablet computer, an Ultrabook™ computer, a mobile internet device, a handheld computer, a handheld device, a Smartphone, a sensor, a wearable device, a watch, a wristwatch, a wrist device, a PDA device, a handheld PDA device, a portable device, a mobile phone, a cellular telephone, a PCS device, a mobile or portable GPS device, a peripheral device, a vehicular device or the like.

In some demonstrative embodiments, at least one of devices 102 and 140 may include a mobile or portable device.

In some demonstrative embodiments, one of devices 102 and 140 may include a mobile or portable device and another one of device 102 and 140 may include a non-portable device. For example, one of devices 102 and 140 may include a mobile device, e.g., a portable computer or a mobile phone, and another one of devices 102 and 140 may include a docking device or another stationary device, e.g., a wireless display.

In some demonstrative embodiments, both devices 102 and 140 may include a mobile or portable device.

In some demonstrative embodiments, devices 102 and 140 may include one or more radios to perform wireless communication between devices 102, 140 and/or one or more other wireless communication devices. For example, device 102 may include at least one radio 114, and/or device 140 may include at least one radio 144 to perform BT wireless communication over the BT channel, e.g., as described below.

In some demonstrative embodiments, radios 114 and/or 144 may include one or more wireless receivers (Rx) to receive wireless communication signals, RF signals, frames, blocks, transmission streams, packets, messages, data items, and/or data. For example, radio 114 may include a receiver 116, and/or radio 144 may include a receiver 146.

In some demonstrative embodiments, radios 114 and/or 144 may include one or more wireless transmitters (Tx) to send wireless communication signals, RF signals, frames, blocks, transmission streams, packets, messages, data items, and/or data. For example, radio 114 may include a transmitter 118, and/or radio 144 may include a transmitter 148.

In some demonstrative embodiments, radios 114 and/or 144 may include modulation elements, demodulation elements, amplifiers, analog to digital and digital to analog converters, filters, and/or the like. For example, radios 114 and/or 144 may include or may be implemented as part of a wireless Network Interface Card (NIC), and the like.

In some demonstrative embodiments, radios 114 and/or 144 may include, or may be associated with, one or more antennas 107 and/or 147, respectively.

In one example, device 102 may include a single antenna 107. In other example, device 102 may include two or more antennas 107.

In one example, device 140 may include a single antenna 147. In other example, device 140 may include two or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a phased array antenna, a multiple element antenna, a set of switched beam antennas, and/or the like. In some embodiments, antennas 107 and/or 147 may implement transmit and receive functionalities using separate transmit and receive antenna elements. In some embodiments, antennas 107 and/or 147 may implement transmit and receive functionalities using common and/or integrated transmit/receive elements.

In some demonstrative embodiments, devices 102 and/or 140 may also include, for example, a processor 191, an input unit 192, an output unit 193, a memory unit 194, and a storage unit 195. Device 102 and/or device 140 may optionally include other suitable hardware components and/or software components. In some demonstrative embodiments, some or all of the components of device 102 and/or device 140 may be enclosed in a common housing or packaging, and may be interconnected or operably associated using one or more wired or wireless links. In other embodiments, components of device 102 and/or device 140 may be distributed among multiple or separate devices.

Processor 191 include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. For example, processor 191 executes instructions, for example, of an Operating System (OS) of device 102 and/or of one or more suitable applications.

Memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 include, for example, a hard disk drive, a floppy disk drive, a Compact Disk (CD) drive, a CD-ROM drive, a DVD drive, or other suitable removable or non-removable storage units. For example, memory unit 194 and/or storage unit 195, for example, may store data processed by device 102.

Input unit 192 includes, for example, a keyboard, a keypad, a mouse, a touch-screen, a touch-pad, a track-ball, a stylus, a microphone, or other suitable pointing device or input device. Output unit 193 includes, for example, a monitor, a screen, a touch-screen, a flat panel display, a Light Emitting Diode (LED) display, a Liquid Crystal Display (LCD) display unit, a plasma display unit, one or more audio speakers or earphones, or other suitable output devices.

In some demonstrative embodiments, device 102 and device 140 may perform one or more proximity measurements between devices 102 and 140 (“the proximity measurements”) to determine proximity between devices 102 and 140, e.g., as described below.

In one example, device 140 may include a wireless display and device 102 may include a Smartphone. The wireless display may display content, data, images and/or video from the Smartphone, for example, when a distance between the Smartphone and the display is less than a predefined distance, e.g., less than 3 meters. According to this example, devices 102 and 140 may perform the proximity measurements to determine, for example, if the distance between devices 102 and 140 is less than the predefined distance, e.g., to enable the display, for example, to display video from the Smartphone.

In another example, device 140 may include a notebook and device 102 may include a key to unlock the notebook. According to this example, devices 102 and 140 may perform the proximity measurements to determine, for example, if the distance between devices 102 and 140 is less than the predefined distance, e.g., to enable the key to unlock the notebook.

In other embodiments, devices 102 and 140 may perform the one or more proximity measurements between devices 102 and 140 for any other applications and/or uses.

In one example, device 140 may include a heart rate monitor to be worn by a user, and device 102 may include a Smartphone to be used by the user. The Smartphone may include an application to monitor the heart rate of the user. According to this example, devices 102 and 140 may perform the proximity measurements to determine, for example, if the user is wearing the heart rate monitor, e.g., when a distance between devices 102 and 140 is less than a predefined distance.

In some demonstrative embodiments, devices 102 and 140 may establish a connection between devices 102 and 140 to perform the proximity measurements between devices 102 and 140.

In some demonstrative embodiments, device 102 may initiate the connection establishment, e.g., device 102 may perform the functionality of the BLE Central Host device, and device 140 may accept the connection establishment, e.g., device 140 may perform the functionality of the BLE Peripheral host device.

In some demonstrative embodiments, devices 102 and/or 140 may include a proximity estimator to determine the proximity between devices 102 and 140. For example, device 102 may include a proximity estimator 112, and/or device 140 may include a proximity estimator 142.

In some demonstrative embodiments, proximity estimators 112 and/or 142 may include circuitry, e.g., processor circuitry, memory circuitry, Media-Access Control (MAC) circuitry, Physical Layer (PHY) circuitry, and/or any other circuitry, configured to perform the functionality of proximity estimators 112 and/or 142. Additionally or alternatively, one or more functionalities of the proximity estimators 112 and/or 142 may be implemented by logic, which may be executed by a machine and/or one or more processors, e.g., as described below.

In some demonstrative embodiments, proximity estimator 112 may be implemented as part of radio 114, and/or proximity estimator 142 may be implemented as part of radio 144. In other embodiments, proximity estimator 112 may be implemented as another element of device 102, and/or proximity estimator 142 may be implemented as another element of device 140.

In some demonstrative embodiments, proximity estimator 112 may determine the proximity between device 102 and device 140 based on the proximity measurements between device 102 and device 140, e.g., as described below.

In some demonstrative embodiments, proximity estimator 112 may perform a proximity measurement between devices 102 and 140 based on at least one message received by device 102 from device 140, e.g., as described below.

In some demonstrative embodiments, the proximity measurement between devices 102 and device 140 may include exchanging of two BT messages, e.g., as describe below.

In some demonstrative embodiments, transmitter 118 may transmit a first BT message 125 to device 140.

In some demonstrative embodiments, receiver 146 may receive message 125, and transmitter 148 may transmit to device 102 a second BT message 145, e.g., in response to message 125.

In some demonstrative embodiments, device 102 may include a message processor 119 configured to generate, process and/or access one or messages communicated by device 102.

In one example, message processor 119 may be configured to generate message 125, and/or to access and/or to process message 145.

In some demonstrative embodiments, device 140 may include a message processor 149 configured to generate, process and/or access one or messages communicated by device 140.

In one example, message processor 149 may be configured to generate message 145, and/or to access and/or to process message 125.

In some demonstrative embodiments, message processors 119 and/or 149 may include circuitry, e.g., processor circuitry, memory circuitry, Media-Access Control (MAC) circuitry, Physical Layer (PHY) circuitry, and/or any other circuitry, configured to perform the functionality of message processors 119 and/or 149. Additionally or alternatively, one or more functionalities of the proximity estimators message processors 119 and/or 149 may be implemented by logic, which may be executed by a machine and/or one or more processors, e.g., as described below.

In some demonstrative embodiments, message processor 119 may be implemented as part of radio 114, and/or message processor 149 may be implemented as part of radio 144.

In some demonstrative embodiments, message processor 119 may be implemented as part of proximity estimator 112, and/or message processor 149 may be implemented as part of proximity estimator 142.

In other embodiments, message processor 119 may be implemented as part of any other element of device 102, and/or message processor 149 may be implemented as part of any other element of device 140.

In some demonstrative embodiments, messages 125 and/or 145 may include Attribute Protocol (ATT) messages.

In some demonstrative embodiments, message 125 may include an ATT read request message, and/or message 145 may include an ATT read response message.

In some demonstrative embodiments, receiver 116 may receive message 145 and may measure a received signal strength of message 145, e.g., when received via antennas 107.

In other embodiments, radio 114 may include a signal strength measurement module 115 to measure the signal strength of message 145 received by receiver 116.

In some demonstrative embodiments, the received signal strength may include a received signal strength indication (RSSI) of the message. In other embodiments, the received signal strength may include any other indication of the signal strength of the received message.

In some demonstrative embodiments, proximity estimator 112 may determine proximity between devices 102 and 140 based on the RSSI of message 145. For example, proximity estimator 112 may determine a power loss of the signal strength of message 145, for example, by comparing a signal strength indication of a transmitted power of message 145, e.g., as transmitted by transmitter 148, and the RSSI of message 145, as received at receiver 116. Proximity estimator 112 may determine the proximity between devices 102 and 140, for example, based on the power loss of message 145 and a predefined power loss per distance.

In some demonstrative embodiments, an accuracy of the proximity between devices 102 and 140, e.g., as determined by proximity estimator 112, may be based on the number of proximity measurements used by proximity estimator 112 to determine the proximity. For example, the accuracy of the determined proximity between devices 102 and 140 may increase if the number of proximity measurements preformed by proximity estimator 112 is increased.

In one example, devices 102 and 140 may perform a relatively large number of proximity measurements during a relatively short period of time, e.g., 10 RSSI measurements every second, for example, to assure a relatively high level of the accuracy.

In some demonstrative embodiments, devices 102 and 140 may repeat exchanging messages 124 and 145 to increase the number of proximity measurements between devices 102 and 140.

In some demonstrative embodiments, repeating the exchanging of messages 125 and 145 may increase a number of messages exchanged between devices 102 and 140.

In some demonstrative embodiments, increasing the number of messages exchanged between devices 102 and 140, may increase power consumption of device 102 and/or device 140.

Some demonstrative embodiments may enable increasing the number of proximity measurements between device 102 and device 140, for example, without increasing the number of messages exchanged between devices 102 and 140.

Some demonstrative embodiments may enable increasing the number of RSSI measurements, for example, without increasing the number of messages exchanged between devices 102 and 140.

In some demonstrative embodiments, proximity estimator 112 may increase the number of proximity measurements between devices 102 and 140, for example, by using a measured RSSI measured by device 140 of a message from device 102 to device 140, e.g., as described below.

In some demonstrative embodiments, proximity estimator 112 may be able to use the RSSI measured by device 140, for example, since the distance between devices 102 and 140 as measured by device 102 may be symmetric to the distance between devices 102 and 140 as measured by device 140.

In one example, even if a first received RSSI of a first message received by device 140 from device 102 may be different and/or measured differentially, e.g., using different methods, hardware, algorithms and/or the like, from a second received RSSI of a second message received by device 102 from device 140, the distance between devices 102 and 140 may be symmetric with respect to the first and second RSSIs.

In some demonstrative embodiments, device 102 may command device 140 to measure the RSSI of BT messages received by device 140, e.g., from device 102. In some demonstrative embodiments, receiver 146 may be configured to measure the RSSI of BT massages from device 102.

In other embodiments, radio 144 may include a signal strength measurement module 143 to measure the signal strength of BT massages from device 102.

In some demonstrative embodiments, transmitter 118 may transmit a command 127 to device 140 to measure the RSSI. In one example, message processor 119 may generate command 127.

In some demonstrative embodiments, receiver 146 may receive command 127, and may measure RSSI of BT massages from device 102, e.g., from reception of command 127. In one example, message processor 149 may cause receiver 146 to measure the RSSI of the BT massages from device 102, e.g., based on command 127.

In some demonstrative embodiments, transmitter 118 may transmit message 125.

In some demonstrative embodiments, receiver 146 may receive message 125 and may measure the RSSI of message 125.

In some demonstrative embodiments, transmitter 148 may transmit massage 145 to device 102, e.g., in response to message 125.

In some demonstrative embodiments, message 145 may include an indication of the RSSI of message 125, e.g., as measured by receiver 146.

In some demonstrative embodiments, receiver 116 may receive message 145 including the indication of the RSSI of message 125.

In some demonstrative embodiments, proximity estimator 112 may estimate the proximity between devices 102 and 140 based on the RSSI of message 125, which is included in message 145.

In some demonstrative embodiments, proximity estimator 112 may measure the RSSI of message 145, e.g., as described above.

In some demonstrative embodiments, proximity estimator 112 may estimate the proximity between devices 102 and 140 based on the RSSI of message 125 and the RSSI of message 145.

In some demonstrative embodiments, proximity estimator 112 may use a mathematical method to estimate the proximity between devices 102 and 140 based on the RSSI of message 125 and the RSSI of message 145. For example, proximity estimator 112 may use a median, an average, or any other mathematical function and/or algorithm, of the RSSI of message 125 and the RSSI of message 145, to estimate the proximity between devices 102 and 140.

In some demonstrative embodiments, using the RSSI of messages 125 and 145 may enable to double a number of RSSI measurements to estimate the proximity between devices 102 and 140, for example, without increasing the number of BT messages exchanged between devices 102 and/or 140, and/or without increasing the power consumption of device 102 and/or 140.

In some demonstrative embodiments, using the RSSI of messages 125 and 145 may enable to determine the proximity or proximity trend between devices 102 and 140, e.g., devices 102 and 140 moving closer or moving apart, for example, without increasing the number of BT messages exchanged between devices 102 and/or 140

In some demonstrative embodiments, device 140 may be capable of estimating the proximity between devices 102 and 140 based on the proximity measurements, e.g., as described below.

In some demonstrative embodiments, proximity estimator 142 may determine the proximity between devices 102 and 140 based on the RSSI of message 125, e.g., as described below, and based on an RSSI measured by device 102 of a message 149 transmitted from device 140 to device 102.

In some demonstrative embodiments, message 149 may include a previous ATT read response message, e.g., transmitted in response to a previous ATT read request message, which may be transmitted from device 140, e.g., prior to message 125.

In some demonstrative embodiments, device 140 may transmit message 149 to device 102.

In some demonstrative embodiments, device 102 may receive message 149, and receiver 116 may measure the RSSI of message 149.

In some demonstrative embodiments, device 125 may transmit message 125 including an indication of the RSSI of message 149.

In some demonstrative embodiments, proximity estimator 142 may determine the proximity between devices 102 and 140 based on both RSSI measurements, e.g., the measured RSSI of message 125 and the measured RSSI of message 149.

In some demonstrative embodiments, devices 102 and 140 may determine the proximity between devices 102 and 140, for example, based on the RSSI of messages 125 and 145 and/or the RSSI of messages 149 and 125, for example, according to a proximity measurement scheme, e.g., as described below.

In some demonstrative embodiments, the proximity measurement scheme may be defined by extending an existing proximity measurement scheme, e.g., to include the RSSI indication in message 145, and/or to communicate command 127.

In some demonstrative embodiments, the proximity measurement scheme may be implemented by a Generic ATT Profile (GATT) application, e.g., as described below.

In some demonstrative embodiments, the GATT application may include a GATT service.

In some demonstrative embodiments, the GATT service may be assigned with a unique identifier, e.g., a unique Service Set Identification (SSID).

In some demonstrative embodiments, the GATT service may be discovered, for example, using a GATT discovery procedure, e.g., a GATT Discover All Primary Services sub-procedure.

In some demonstrative embodiments, the GATT service may include one or more characteristics, e.g., as follows:

TABLE 1

| | | | | |
|---|---|---|---|---|
| characteristic | | Mandatory | Optional | Security |
| Name | Requirement | Properties | Properties | Permissions |

| | | | |
|---|---|---|---|
| RSSI | Mandatory | Write | None |
| Calculate Flag | | | |
| Rx Power | Mandatory | Read | None |

In some demonstrative embodiments, the GATT service may include an indication (“RSSI calculate Flag”) to indicate whether or not a device, e.g., device 140, is to perform RSSI measurements, and send a message including an indication of the RSSI measurements.

In some demonstrative embodiments, device 102 may set the RSSI Calculate Flag in Table 1 of the GATT service to a first predefined value, e.g., 0×1, to command device 140 to measure the RSSI.

In some demonstrative embodiments, device 102 may set the RSSI Calculate Flag in Table 1 of the GATT service to a second predefined value, e.g., 0×0, to command device 140 to stop measuring the RSSI.

In some demonstrative embodiments, the GATT service may include a characteristic (“Rx Power”) to indicate that the RSSI measurement is being performed, or a measured value of the RSSI measurement, e.g., as described below.

In some demonstrative embodiments, device 102 may send message 125 including the RX power characteristic of Table 1 set to “read”, e.g., to update the GATT service, that device 140 is to measure the RSSI.

In some demonstrative embodiments, device 140 may send message 145 including the RX power characteristic set to the RSSI value of the measured RSSI of message 125.

In some demonstrative embodiments, the RSSI value in the RX power characteristic of Table 1 may include an absolute value e.g., in decibels (dB), of a predefined range, e.g., between −127 dB and 127 dB, with a marginal accuracy error, e.g., of +/−6 dB.

In one example, the RSSI value in the RX power characteristic of Table 1 may include a predefined value, e.g., of 127 dB, for example, if the RSSI cannot be read and/or measured.

In other embodiments, devices 102 and/or 140 may communicate command and/or messages 125 and/or 145 according to any other scheme and/or format.

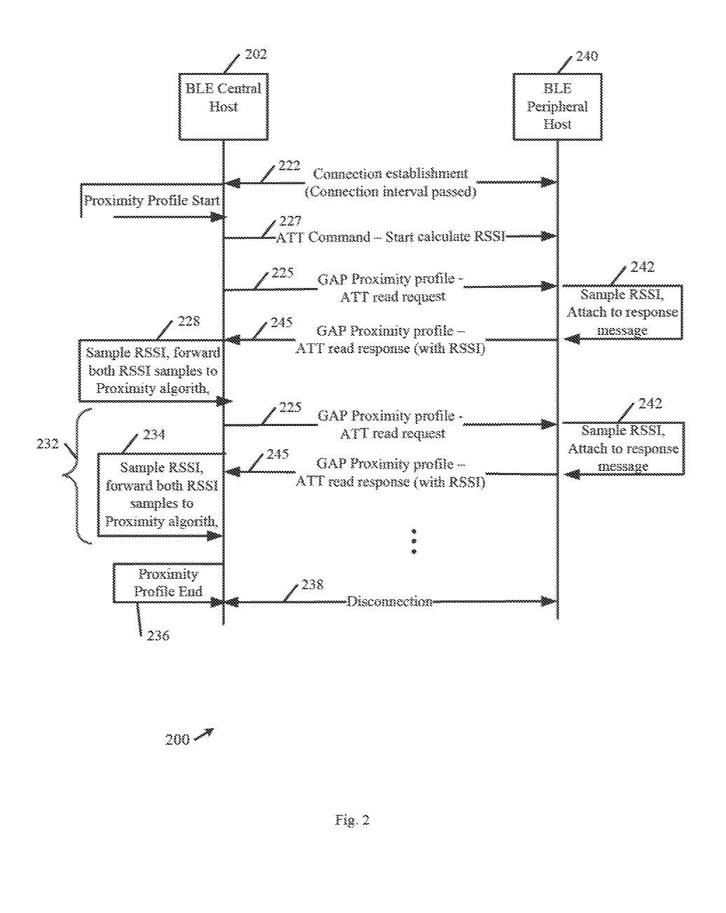

Reference is made to FIG. 2, which schematically illustrates a sequence diagram 200, which demonstrates operations and interactions between a BLE Central Host device 202 and a BLE Peripheral Host device 240, in accordance with some demonstrative embodiments. For example, BLE Central Host device 202 may perform the functionality of device 102 (FIG. 1), and/or BLE Peripheral Host device 240 may perform the functionality of device 140 (FIG. 1).

As shown in FIG. 2, devices 202 and 240 may establish (222) a connection between devices 202 and 240. For example, devices 102 and 140 (FIG. 1) may establish the connection between devices 102 and 140 (FIG. 1), e.g., as described above.

As shown in FIG. 2, device 202 may transmit to device 240 a command message 227 to command device 240 to measure the RSSI of messages received from device 202. For example, device 102 (FIG. 1) may transmit command 127 (FIG. 1) to device 140 (FIG. 1), e.g., as described above.

As shown in FIG. 2, device 202 may transmit to device 240 an ATT read request message 225. For example, device 102 (FIG. 1) may transmit message 125 (FIG. 1) to device 140 (FIG. 1), e.g., as described above.

As shown in FIG. 2, device 240 may receive ATT read request message 225, and may measure (242) an RSSI of ATT read request message 225. For example, device 140 (FIG. 1) may receive message 125 (FIG. 1), and may measure the RSSI of message 125 (FIG. 1), e.g., as described above.

As shown in FIG. 2, device 240 may transmit to device 202 an ATT read response message 245 including the measured RSSI of message 225. For example, device 140 (FIG. 1) may transmit to device 102 (FIG. 1) the message 145 (FIG. 1) including the measured RSSI of message 125 (FIG. 1), e.g., as described above.

As shown in FIG. 2, device 202 may receive ATT read response message 245 from device 240, and may measure (228) an RSSI of ATT read response message 245. For example, device 102 (FIG. 1) may receive message 145 (FIG. 1) from device 140 (FIG. 1), and may measure the RSSI of message 145 (FIG. 1), e.g., as described above.

As shown in FIG. 2, device 202 may perform a proximity measurement between devices 202 and 240 based on the RSSI measurement of message 225 and the RSSI measurement message 245. For example, proximity estimator 112 (FIG. 1) may estimate the proximity between devices 102 and 140 (FIG. 1) based on the RSSI of message 125 (FIG. 1), and the RSSI of message 145 (FIG. 1), e.g., as described above.

As shown in FIG. 2, device 202 may repeat (232) exchanging messages 225 and 245 to perform additional proximity measurements (234) between devices 202 and 240 based on both RSSI samples of message 225 and message 245. For example, proximity estimator 112 (FIG. 1) may repeat exchanging of messages 125 and 145 (FIG. 1) to perform additional proximity measurements between devices 102 and 140 (FIG. 1), e.g., as described below.

As shown in FIG. 2, device 202 may terminate (236) the proximity measurements between devices 202 and 240. For example, device 102 (FIG. 1) may terminate the proximity measurements between devices 102 and 140 (FIG. 1), e.g., as described above.

As shown in FIG. 2, devices 202 and 240 may disconnect (238) the connection between devices 202 and 240. For example, devices 102 and 140 (FIG. 1) may disconnect the connection between devices 102 and 140 (FIG. 1).

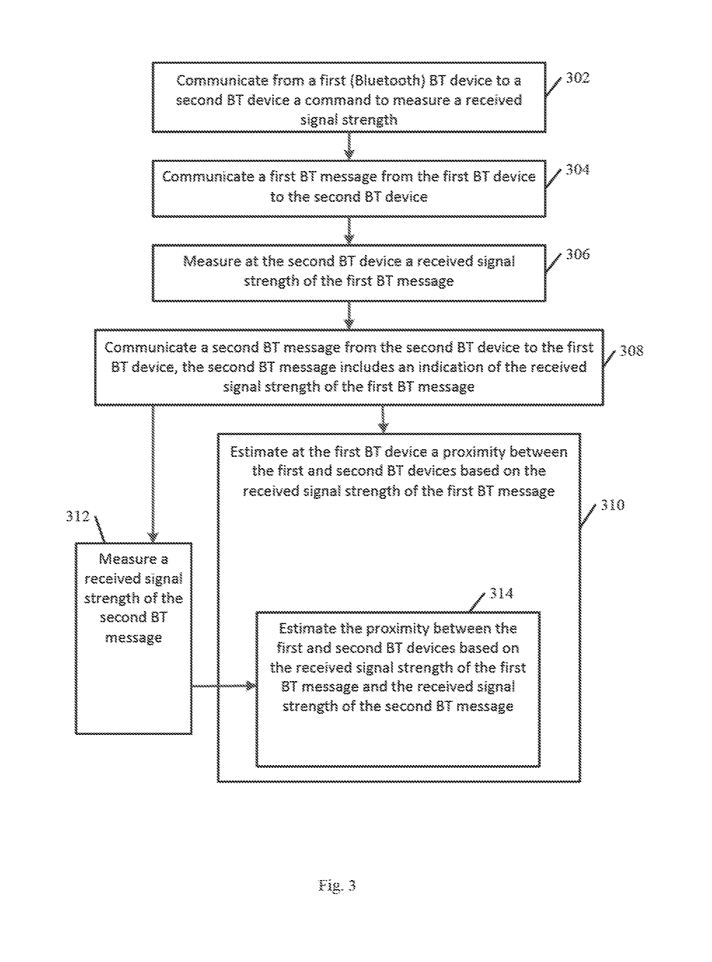

Reference is now made to FIG. 3, which schematically illustrates a method of proximity measurement, in accordance with some demonstrative embodiments. For example, one or more of the operations of the method of FIG. 3 may be performed by a wireless communication system, e.g., system 100 (FIG. 1); a wireless communication device, e.g., device 140 (FIG. 1) and/or device 102 (FIG. 1), a proximity estimator, e.g., proximity estimator 112 (FIG. 1) and/or proximity estimator 144 (FIG. 1); a transmitter, e.g., transmitter 118 and/or transmitter 148 (FIG. 1); and/or a receiver, e.g., receiver 116 and/or receiver 146 (FIG. 1).

As indicated at block 302, the method may include communicating a command from a first BT device to a second BT device to measure a received signal strength. For example, device 102 (FIG. 1) may transmit command 127 (FIG. 1) to device 140 (FIG. 1), e.g., as described above.

As indicated at block 304, the method may include communicating a first BT message from the first BT device to the second BT device. For example, device 102 (FIG. 1) may transmit message 125 (FIG. 1) to device 140 (FIG. 1), e.g., as described above.

As indicated at block 306, the method may include measuring at the second BT device a received signal strength of the first BT message. For example, device 140 (FIG. 1) may measure the RSSI of message 125 (FIG. 1), e.g., as described above.

As indicated at block 308, the method may include communicating a second BT message from the second BT device to the first BT device, the second BT message including an indication of the received signal strength of the first BT message. For example, device 140 (FIG. 1) may transmit to device 102 (FIG. 1) message 145 (FIG. 1) including the measured RSSI of message 225 (FIG. 1), e.g., as described above.

As indicated at block 310, the method may include estimating at the first BT device a proximity between the first and second BT devices based on the received signal strength of the first BT message. For example, proximity estimator 112 (FIG. 1) may estimate the proximity between devices 102 and 140 (FIG. 1) based on the RSSI of message 125 (FIG. 1), e.g., as described above.

As indicated at block 312, the method may include measuring a received signal strength of the second BT message. For example, receiver 116 (FIG. 1) may measure the RSSI of message 145 (FIG. 1), e.g., as described above.

As indicated at block 314, estimating the proximity between the first and second BT devices may include estimating the proximity between the first and second BT devices, based on the received signal strength of the first BT message and the received signal strength of the second BT message. For example, proximity estimator 112 (FIG. 1) may estimate the proximity between devices 102 and 140 (FIG. 1) based on the RSSI of message 125 (FIG. 1) and the RSSI of message 145 (FIG. 1), e.g., as described above.

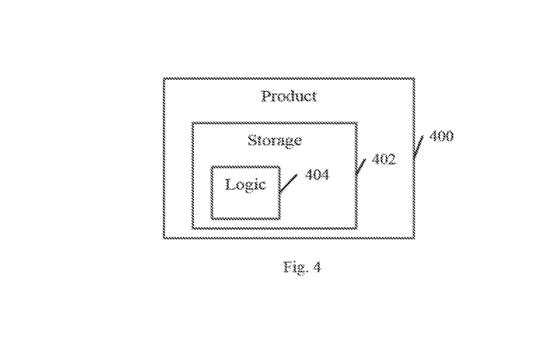

Reference is made to FIG. 4, which schematically illustrates a product of manufacture 400, in accordance with some demonstrative embodiments. Product 400 may include a non-transitory machine-readable storage medium 402 to store logic 404, which may be used, for example, to perform at least part of the functionality of device 102 (FIG. 1), device 140 (FIG. 1), proximity estimator 112 (FIG. 1), proximity estimator 144 (FIG. 1), message processors 119 and/or 149 (FIG. 1), transmitters 118 and/or 148 (FIG. 1), receivers 116 and/or 146 (FIG. 1), and/or to perform one or more operations of the method of FIG. 3. The phrase “non-transitory machine-readable medium” is directed to include all computer-readable media, with the sole exception being a transitory propagating signal.

In some demonstrative embodiments, product 400 and/or machine-readable storage medium 402 may include one or more types of computer-readable storage media capable of storing data, including volatile memory, non-volatile memory, removable or non-removable memory, erasable or non-erasable memory, writeable or re-writeable memory, and the like. For example, machine-readable storage medium 402 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 404 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 404 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes a first Bluetooth (BT) device comprising a transmitter to transmit a first BT message to a second BT device; a receiver to receive from the second BT device a second BT message including an indication of a received signal strength of the first message; and a proximity estimator to estimate a proximity between the first and second BT devices based on the received signal strength of the first BT message.

Example 2 includes the subject matter of Example 1, and optionally, wherein the receiver is to measure a received signal strength of the second BT message, the proximity estimator is to estimate the proximity between the first and second BT devices, based on the received signal strength of the first BT message and the received signal strength of the second BT message.

Example 3 includes the subject matter of Example 1 or 2, and optionally, wherein the first and second BT messages comprise Attribute Protocol (ATT) messages.

Example 4 includes the subject matter of Example 3, and optionally, wherein the first BT message comprises an ATT read request message, and the second BT message comprises an ATT read response message.

Example 5 includes the subject matter of any one of Examples 1-4, and optionally, wherein the transmitter is to transmit to the second BT device a command to measure the received signal strength.

Example 6 includes the subject matter of any one of Examples 1-5 being a Bluetooth Low Energy (BLE) Central Host device.

Example 7 includes the subject matter of any one of Examples 1-3, and optionally, wherein the first BT message comprises an Attribute Protocol (ATT) read response message, and the second BT message comprises an ATT read request message.

Example 8 includes the subject matter of Example 7 being a Bluetooth Low Energy (BLE) Peripheral Host device.

Example 9 includes the subject matter of any one of Examples 1-8, and optionally, wherein the signal strength of the first BT message comprises a Receive Signal Strength Indication (RSSI) corresponding to the first BT message.

Example 10 includes the subject matter of any one of Examples 1-9, and optionally, comprising one or more antennas; a memory; and a processor.

Example 11 includes a first Bluetooth (BT) device comprising a receiver to receive from a second BT device a command to measure a received signal strength, to receive a first BT message from the second BT device, and to measure a received signal strength of the first BT message; and a transmitter to transmit to the second BT device a second BT message including an indication of the received signal strength of the first BT message.

Example 12 includes the subject matter of Example 11, and optionally, wherein the first and second BT messages comprise Attribute Protocol (ATT) messages.

Example 13 includes the subject matter of Example 12, and optionally, wherein the first BT message comprises an ATT read request message, and the second BT message comprises an ATT read response message.

Example 14 includes the subject matter of any one of Examples 11-13, and optionally, comprising a proximity estimator to estimate a proximity between the first and second BT devices based on the received signal strength of the first BT message.

Example 15 includes the subject matter of any one of Examples 11-14 being a Bluetooth Low Energy (BLE) Peripheral Host device.

Example 16 includes the subject matter of any one of Examples 11-15, and optionally, wherein the received signal strength of the first BT message comprises a Receive Signal Strength Indication (RSSI) corresponding to the first BT message.

Example 17 includes the subject matter of any one of Examples 11-16, and optionally, comprising one or more antennas; a memory; and a processor.

Example 18 includes a system comprising a first Bluetooth (BT) device comprising one or more antennas; a memory; a processor; a transmitter to transmit a first BT message to a second BT device; a receiver to receive from the second BT device a second BT message including an indication of a received signal strength of the first message; and a proximity estimator to estimate a proximity between the first and second BT devices based on the received signal strength of the first BT message.

Example 19 includes the subject matter of Example 18, and optionally, wherein the receiver is to measure a received signal strength of the second BT message, the proximity estimator is to estimate the proximity between the first and second BT devices, based on the received signal strength of the first BT message and the received signal strength of the second BT message.

Example 20 includes the subject matter of Example 18 or 19, and optionally, wherein the first and second BT messages comprise Attribute Protocol (ATT) messages.

Example 21 includes the subject matter of Example 20, and optionally, wherein the first BT message comprises an ATT read request message, and the second BT message comprises an ATT read response message.

Example 22 includes the subject matter of any one of Examples 18-21, and optionally, wherein the transmitter is to transmit to the second BT device a command to measure the received signal strength.

Example 23 includes the subject matter of any one of Examples 18-22, and optionally, wherein the first BT device being a Bluetooth Low Energy (BLE) Central Host device.

Example 24 includes the subject matter of any one of Examples 18-20, and optionally, wherein the first BT message comprises an Attribute Protocol (ATT) read response message, and the second BT message comprises an ATT read request message.

Example 25 includes the subject matter of Example 24, and optionally, wherein the first BT device being a Bluetooth Low Energy (BLE) Peripheral Host device.

Example 26 includes the subject matter of any one of Examples 18-25, and optionally, wherein the signal strength of the first BT message comprises a Receive Signal Strength Indication (RSSI) corresponding to the first BT message.

Example 27 includes a system comprising a first Bluetooth (BT) device comprising one or more antennas; a memory; a processor; a receiver to receive from a second BT device a command to measure a received signal strength, to receive a first BT message from the second BT device, and to measure a received signal strength of the first BT message; and a transmitter to transmit to the second BT device a second BT message including an indication of the received signal strength of the first BT message.

Example 28 includes the subject matter of Example 27, and optionally, wherein the first and second BT messages comprise Attribute Protocol (ATT) messages.

Example 29 includes the subject matter of Example 28, and optionally, wherein the first BT message comprises an ATT read request message, and the second BT message comprises an ATT read response message.

Example 30 includes the subject matter of any one of Examples 27-29, and optionally, comprising a proximity estimator to estimate a proximity between the first and second BT devices based on the received signal strength of the first BT message.

Example 31 includes the subject matter of any one of Examples 27-30, and optionally, wherein the first BT device being a Bluetooth Low Energy (BLE) Peripheral Host device.

Example 32 includes the subject matter of any one of Examples 27-31, and optionally, wherein the received signal strength of the first BT message comprises a Receive Signal Strength Indication (RSSI) corresponding to the first BT message.

Example 33 includes a method to be performed at a first Bluetooth (BT) device, the method comprising transmitting a first BT message to a second BT device; receiving from the second BT device a second BT message including an indication of a received signal strength of the first BT message; and estimating a proximity between the first and second BT devices based on the received signal strength of the first BT message.

Example 34 includes the subject matter of Example 33, and optionally, comprising measuring a received signal strength of the second BT message, and estimating the proximity between the first and second BT devices, based on the received signal strength of the first BT message and the received signal strength of the second BT message.

Example 35 includes the subject matter of Example 33 or 34, and optionally, wherein the first and second BT messages comprise Attribute Protocol (ATT) messages.

Example 36 includes the subject matter of Example 35, and optionally, wherein the first BT message comprises an ATT read request message, and the second BT message comprises an ATT read response message.

Example 37 includes the subject matter of any one of Examples 33-36, and optionally, comprising transmitting to the second BT device a command to measure the received signal strength.

Example 38 includes the subject matter of any one of Examples 33-37, and optionally, wherein the first BT device being a Bluetooth Low Energy (BLE) Central Host device.

Example 39 includes the subject matter of any one of Examples 33-35, and optionally, wherein the first BT message comprises an Attribute Protocol (ATT) read response message, and the second BT message comprises an ATT read request message.

Example 40 includes the subject matter of Example 39, and optionally, wherein the first BT device being a Bluetooth Low Energy (BLE) Peripheral Host device.

Example 41 includes the subject matter of any one of Examples 33-40, and optionally, wherein the signal strength of the first BT message comprises a Receive Signal Strength Indication (RSSI) corresponding to the first BT message.

Example 42 includes a method to be performed at a first Bluetooth (BT) device, the method comprising receiving from a second BT device a command to measure a received signal strength; receiving a first BT message from the second BT device; measuring a received signal strength of the first BT message; and transmitting to the second BT device a second BT message including an indication of the received signal strength of the first BT message.

Example 43 includes the subject matter of Example 42, and optionally, wherein the first and second BT messages comprise Attribute Protocol (ATT) messages.

Example 44 includes the subject matter of Example 43, and optionally, wherein the first BT message comprises an ATT read request message, and the second BT message comprises an ATT read response message.

Example 45 includes the subject matter of any one of Examples 42-44, and optionally, comprising estimating a proximity between the first and second BT devices based on the received signal strength of the first BT message.

Example 46 includes the subject matter of any one of Examples 42-45, and optionally, wherein the first BT device being a Bluetooth Low Energy (BLE) Peripheral Host device.

Example 47 includes the subject matter of any one of Examples 42-46, and optionally, wherein the received signal strength of the first BT message comprises a Receive Signal Strength Indication (RSSI) corresponding to the first BT message.

Example 48 includes a product including one or more tangible computer-readable non-transitory storage media comprising computer-executable instructions operable to, when executed by at least one computer processor, enable the at least one computer processor to implement a method at a first Bluetooth (BT) device, the method comprising transmitting a first BT message to a second BT device; receiving from the second BT device a second BT message including an indication of a received signal strength of the first BT message; and estimating a proximity between the first and second BT devices based on the received signal strength of the first BT message.

Example 49 includes the subject matter of Example 48, wherein the method comprises measuring a received signal strength of the second BT message, and estimating the proximity between the first and second BT devices, based on the received signal strength of the first BT message and the received signal strength of the second BT message.

Example 50 includes the subject matter of Example 48 or 49, and optionally, wherein the first and second BT messages comprise Attribute Protocol (ATT) messages.

Example 51 includes the subject matter of Example 50, and optionally, wherein the first BT message comprises an ATT read request message, and the second BT message comprises an ATT read response message.

Example 52 includes the subject matter of any one of Examples 48-51, and optionally, wherein the method comprises transmitting to the second BT device a command to measure the received signal strength.

Example 53 includes the subject matter of any one of Examples 48-52, and optionally, wherein the first BT device being a Bluetooth Low Energy (BLE) Central Host device.

Example 54 includes the subject matter of any one of Examples 48-50, and optionally, wherein the first BT message comprises an Attribute Protocol (ATT) read response message, and the second BT message comprises an ATT read request message.

Example 55 includes the subject matter of Example 54, and optionally, wherein the first BT device being a Bluetooth Low Energy (BLE) Peripheral Host device.

Example 56 includes the subject matter of any one of Examples 48-55, and optionally, wherein the signal strength of the first BT message comprises a Receive Signal Strength Indication (RSSI) corresponding to the first BT message.

Example 57 includes a product including one or more tangible computer-readable non-transitory storage media comprising computer-executable instructions operable to, when executed by at least one computer processor, enable the at least one computer processor to implement a method at a first Bluetooth (BT) device, the method comprising receiving from a second BT device a command to measure a received signal strength; receiving a first BT message from the second BT device; measuring a received signal strength of the first BT message; and transmitting to the second BT device a second BT message including an indication of the received signal strength of the first BT message.

Example 58 includes the subject matter of Example 57, and optionally, wherein the first and second BT messages comprise Attribute Protocol (ATT) messages.

Example 59 includes the subject matter of Example 58, and optionally, wherein the first BT message comprises an ATT read request message, and the second BT message comprises an ATT read response message.

Example 60 includes the subject matter of any one of Examples 57-59, and optionally, wherein the method comprises estimating a proximity between the first and second BT devices based on the received signal strength of the first BT message.

Example 61 includes the subject matter of any one of Examples 57-60, and optionally, wherein the first BT device being a Bluetooth Low Energy (BLE) Peripheral Host device.

Example 62 includes the subject matter of any one of Examples 57-61, and optionally, wherein the received signal strength of the first BT message comprises a Receive Signal Strength Indication (RSSI) corresponding to the first BT message.

Example 63 includes an apparatus comprising means for transmitting a first Bluetooth (BT) message from a first BT device to a second BT device; means for receiving from the second BT device a second BT message including an indication of a received signal strength of the first BT message; and means for estimating a proximity between the first and second BT devices based on the received signal strength of the first BT message.

Example 64 includes the subject matter of Example 63, and optionally, comprising means for measuring a received signal strength of the second BT message, and means for estimating the proximity between the first and second BT devices, based on the received signal strength of the first BT message and the received signal strength of the second BT message.

Example 65 includes the subject matter of Example 63 or 64, and optionally, wherein the first and second BT messages comprise Attribute Protocol (ATT) messages.

Example 66 includes the subject matter of Example 65, and optionally, wherein the first BT message comprises an ATT read request message, and the second BT message comprises an ATT read response message.

Example 67 includes the subject matter of any one of Examples 63-66, and optionally, comprising means for transmitting to the second BT device a command to measure the received signal strength.

Example 68 includes the subject matter of any one of Examples 63-67, and optionally, wherein the first BT device being a Bluetooth Low Energy (BLE) Central Host device.

Example 69 includes the subject matter of any one of Examples 63-65, and optionally, wherein the first BT message comprises an Attribute Protocol (ATT) read response message, and the second BT message comprises an ATT read request message.

Example 70 includes the subject matter of Example 69, and optionally, wherein the first BT device being a Bluetooth Low Energy (BLE) Peripheral Host device.

Example 71 includes the subject matter of any one of Examples 63-70, and optionally, wherein the signal strength of the first BT message comprises a Receive Signal Strength Indication (RSSI) corresponding to the first BT message.

Example 72 includes an apparatus comprising means for, at a first Bluetooth (BT) device, receiving from a second BT device a command to measure a received signal strength; means for receiving a first BT message from the second BT device; means for measuring a received signal strength of the first BT message; and means for transmitting to the second BT device a second BT message including an indication of the received signal strength of the first BT message.

Example 73 includes the subject matter of Example 72, and optionally, wherein the first and second BT messages comprise Attribute Protocol (ATT) messages.

Example 74 includes the subject matter of Example 73, and optionally, wherein the first BT message comprises an ATT read request message, and the second BT message comprises an ATT read response message.

Example 75 includes the subject matter of any one of Examples 72-74, and optionally, comprising means for estimating a proximity between the first and second BT devices based on the received signal strength of the first BT message.

Example 76 includes the subject matter of any one of Examples 72-75, and optionally, wherein the first BT device being a Bluetooth Low Energy (BLE) Peripheral Host device.

Example 77 includes the subject matter of any one of Examples 72-76, and optionally, wherein the received signal strength of the first BT message comprises a Receive Signal Strength Indication (RSSI) corresponding to the first BT message.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. A first Bluetooth (BT) device comprising:
a transmitter to transmit a first BT message to a second BT device;
a receiver to receive from said second BT device a second BT message including an indication of a received signal strength of said first message; and
a proximity estimator to estimate a proximity between said first and second BT devices based on the received signal strength of said first BT message.

2. The first BT device of claim 1, wherein said receiver is to measure a received signal strength of said second BT message, said proximity estimator is to estimate the proximity between said first and second BT devices, based on the received signal strength of said first BT message and the received signal strength of said second BT message.

3. The first BT device of claim 1, wherein said first and second BT messages comprise Attribute Protocol (ATT) messages.

4. The first BT device of claim 3, wherein said first BT message comprises an ATT read request message, and said second BT message comprises an ATT read response message.

5. The first BT device of claim 1, wherein said transmitter is to transmit to said second BT device a command to measure said received signal strength.

6. The first BT device of claim 1 being a Bluetooth Low Energy (BLE) Central Host device.

7. The first BT device of claim 1, wherein said first BT message comprises an Attribute Protocol (ATT) read response message, and said second BT message comprises an ATT read request message.

8. The first BT device of claim 7 being a Bluetooth Low Energy (BLE) Peripheral Host device.

9. The first BT device of claim 1, wherein the signal strength of said first BT message comprises a Receive Signal Strength Indication (RSSI) corresponding to said first BT message.

10. The first BT device of claim 1 comprising:
one or more antennas;
a memory; and
a processor.

11. A first Bluetooth (BT) device comprising:
a receiver to receive from a second BT device a command to measure a received signal strength, to receive a first BT message from said second BT device, and to measure a received signal strength of said first BT message; and
a transmitter to transmit to said second BT device a second BT message including an indication of the received signal strength of said first BT message.

12. The first BT device of claim 11, wherein said first and second BT messages comprise Attribute Protocol (ATT) messages.

13. The first BT device of claim 12, wherein said first BT message comprises an ATT read request message, and said second BT message comprises an ATT read response message.

14. The first BT device of claim 11 comprising a proximity estimator to estimate a proximity between said first and second BT devices based on the received signal strength of said first BT message.

15. The first BT device of claim 11 being a Bluetooth Low Energy (BLE) Peripheral Host device.

16. The first BT device of claim 11, wherein the received signal strength of said first BT message comprises a Receive Signal Strength Indication (RSSI) corresponding to said first BT message.

17. The first BT device of claim 11 comprising:
one or more antennas;
a memory; and
a processor.

18. A product including one or more tangible computer-readable non-transitory storage media comprising computer-executable instructions operable to, when executed by at least one computer processor, enable the at least one computer processor to implement a method at a first Bluetooth (BT) device, the method comprising:
transmitting a first BT message to a second BT device;
receiving from said second BT device a second BT message including an indication of a received signal strength of said first BT message; and
estimating a proximity between said first and second BT devices based on the received signal strength of said first BT message.

19. The product of claim 18, wherein said method comprises measuring a received signal strength of said second BT message, and estimating the proximity between said first and second BT devices, based on the received signal strength of said first BT message and the received signal strength of said second BT message.

20. The product of claim 18, wherein said first and second BT messages comprise Attribute Protocol (ATT) messages.

21. The product of claim 20, wherein said first BT message comprises an ATT read request message, and said second BT message comprises an ATT read response message.

22. A product including one or more tangible computer-readable non-transitory storage media comprising computer-executable instructions operable to, when executed by at least one computer processor, enable the at least one computer processor to implement a method at a first Bluetooth (BT) device, the method comprising:
receiving from a second BT device a command to measure a received signal strength;
receiving a first BT message from said second BT device;
measuring a received signal strength of said first BT message; and
transmitting to said second BT device a second BT message including an indication of the received signal strength of said first BT message.

23. The product of claim 22, wherein said first and second BT messages comprise Attribute Protocol (ATT) messages.

24. The product of claim 23, wherein said first BT message comprises an ATT read request message, and said second BT message comprises an ATT read response message.

25. The product of claim 22, wherein said method comprises estimating a proximity between said first and second BT devices based on the received signal strength of said first BT message.
